(19) United States
(12) Patent Application Publication
(10) Pub. No.: US 2009/0032652 A1
(43) Pub. Date: Feb. 5, 2009

(54) SYSTEM FOR MOVING AND STORING A CONDUIT FOR SUPPLYING AIR TO AN AIRCRAFT

(76) Inventors: Anatoly Gosis, Palatine, IL (US); Scott Takayuki Koizumi, Fairfield, CA (US); Folkert Fred Koch, San Ramon, CA (US); Brian Michael Piety, Vacaville, CA (US); Dennis Bednarz, Glenview, IL (US)

Correspondence Address: Jack M. Cook;Quarles & Brady, LLP., 411 E. Wisconsin Ave., Milwaukee, WI, 53202-4497, US

(21) Appl. No.: 12/140,788

(22) Filed: Jun. 17, 2008

Related U.S. Application Data
(60) Provisional application No. 60/961,174, filed on Jul. 19, 2007.
(60) Provisional application No. 60/961,178, filed on Jul. 19, 2007.

(51) Int. Cl. B05B 15/06

(52) U.S. Cl. 248/75

(57) ABSTRACT

A system for supporting a hose configured to deliver preconditioned air from a source to an aircraft is disclosed. The system includes a base support and a stationary bearing assembly connected to the base support proximate a first end of the stationary bearing assembly. The stationary bearing assembly is configured to engage the hose to support the hose. The system also includes a frame assembly connected to the stationary bearing assembly proximate a second end of the stationary bearing assembly. The frame assembly has a support extending away from the frame assembly that is configured to engage the hose.

### REFERENCE TO RELATED APPLICATIONS

The present application is based on U.S. Provisional Patent Application Ser. No. 60/961,174, entitled “System for Controlled Dispensing of Flexible Pneumatic or Hydraulic Media Conduit by Incrementally Programmed Linear Propulsion,” filed Jul. 19, 2007, and claims the benefit thereof, and U.S. Provisional Patent Application Ser. No. 60/961,178, entitled “System for Controlled Dispensing of Flexible Pneumatic or Hydraulic Media Conduit Regardless of its Functionary Status,” filed Jul. 19, 2007, and claims the benefit thereof.

### STATEMENT REGARDING FEDERALLY SPONSORED RESEARCH OR DEVELOPMENT

Not applicable.

### BACKGROUND OF THE INVENTION

The present invention relates generally to a system and method for connecting a source of preconditioned air to a receiver for the preconditioned air, typically an aircraft. More particularly, the present invention relates to a system for storing and moving a hose leading from the source of preconditioned air to an aircraft. The system reduces the potential for damaging the hose due to sliding friction against components of the system and facilitates efficient storage and dispensing of the hose.

When an aircraft is at rest on the ground, the aircraft is often connected to a source of preconditioned air. That is, rather than tax the onboard heating or air-conditioning systems of the aircraft, a connection is made to a ground source that provides heated or air-conditioned air to the aircraft. To facilitate such a connection, a hose is extended from the preconditioned air source to a standardized hatch door located, generally, on the underside of the aircraft. To create a secure connection between the hose and the aircraft, a standard air chute is typically used that mates and locks with the area about the hatch door through a clamping or similar fixed connection system.

After departure of the aircraft, it is preferable to move the hose to a position where the hose is less likely to be damaged, for example, by airport vehicles or direct exposure to precipitation and other elements. Some hoses are provided in multiple detachable segments and, as such, an operator may disassemble the segments for storage. Other hoses are flexible and, as such, an operator may fold, roll, or compress the hose into a more compact position for storage. However, such tasks can be time consuming for operators and, thus, may not be consistently performed.

Some systems have been developed that attempt to alleviate this problem. For flexible hoses in particular, systems have been developed that retract the hose into a storage position without operator assistance. An example of such a system is shown in FIG. 1. The prior art storage system 10 includes drive mechanisms 12 that move a flexible hose 14 between a use position and a storage position. The hose 14 is axially compressed and supported by a rigid tube 16 in the storage position. To dispense the hose 14 the drive mechanisms 12 may drive in the opposite direction to push the hose 14 from the tube 16. The prior art system 10 optionally includes actuators 18 that release the drive mechanisms 12 from engagement with the hose 14 to permit the hose 14 to be manually pulled from the storage position.

However, the drive mechanisms of systems such as those shown in FIG. 1 typically result in high friction between the inner surface of the hose 14 and the tube 16. The high friction can cause wear on the hose 14 that may render the hose 14 ineffective for supplying preconditioned air. In addition, providing additional components within the hose, such as the tube, increases the weight of the system and the resistance to airflow resulting in reduced airflow efficiency. Therefore, increased power input may be necessary to deliver preconditioned air to the aircraft. Further still, systems such as those shown in FIG. 1 typically dispense and retract the hose slowly.

Therefore, it would be desirable to have a system for storing and moving a hose without reducing the product life of the hose and that permits preconditioned air to be delivered efficiently.

### BRIEF SUMMARY OF THE INVENTION

The present invention overcomes the aforementioned drawbacks by providing a light-weight system for moving a preconditioned air hose. The system is designed to move the hose without reducing the product life of the hose and permit preconditioned air to be delivered efficiently.

In accordance with one aspect of the invention, a system for supporting a hose configured to deliver preconditioned air from a source to an aircraft is disclosed. The system includes a base support and a stationary bearing assembly connected to the base support proximate a first end of the stationary bearing assembly. The stationary bearing assembly is configured to engage the hose to support the hose. The system also includes a frame assembly connected to the stationary bearing assembly proximate a second end of the stationary bearing assembly. The frame assembly has a support extending away from the frame assembly that is configured to engage the hose.

In accordance with another aspect of the invention, a system for supporting a hose configured to deliver preconditioned air from a source to an aircraft is disclosed. The system includes a base support and a plurality of longitudinal members connected to the base support proximate a first end of the plurality of longitudinal members. The plurality of longitudinal members are configured to engage an inner surface of the hose to support the hose. The system also includes a frame assembly connected to the plurality of longitudinal members proximate a second end of the plurality of longitudinal members. The frame assembly includes a plurality of supports extending away from the frame assembly that are configured to engage the inner surface of the hose.

In accordance with another aspect of the invention, a kit for retrofitting a system for supporting a hose for delivering preconditioned air to an aircraft is provided. The kit includes a base support and a stationary bearing assembly configured to connect to the base support and extend from base support in a travel direction of the hose. The stationary bearing assembly is configured to engage the hose to support the hose. The kit also includes a frame assembly configured to connect to the stationary bearing assembly at a position spaced apart from the base support in the travel direction of the hose. The frame assembly includes a support extending away from the frame assembly that is configured to engage the hose.

Various other features of the present invention will be made apparent from the following detailed description and the drawings.

### BRIEF DESCRIPTION OF THE SEVERAL VIEWS OF THE DRAWINGS

The invention will hereafter be described with reference to the accompanying drawings, wherein like reference numerals denote like elements, and:

FIG. 1 is a cross-sectional view of a prior art system for moving a flexible hose for providing preconditioned air to an aircraft;

FIG. 2 is a side-elevational view of a system for moving a preconditioned air hose in accordance with the present invention;

FIG. 3 is a side-elevational view of the system of FIG. 2 with a preconditioned air hose in a storage position;

FIG. 4 is a side-elevational view of the system of FIG. 2 with the preconditioned air hose in a deployed position;

FIG. 5 is a top view of the system of FIG. 2;

FIG. 6 is a front view of the system of FIG. 2 in addition to a frame and grippers;

FIG. 7 is a front view of system of FIG. 2 in addition to a frame and retraction rollers; and

FIG. 8 is a rear view of the system of FIG. 2.

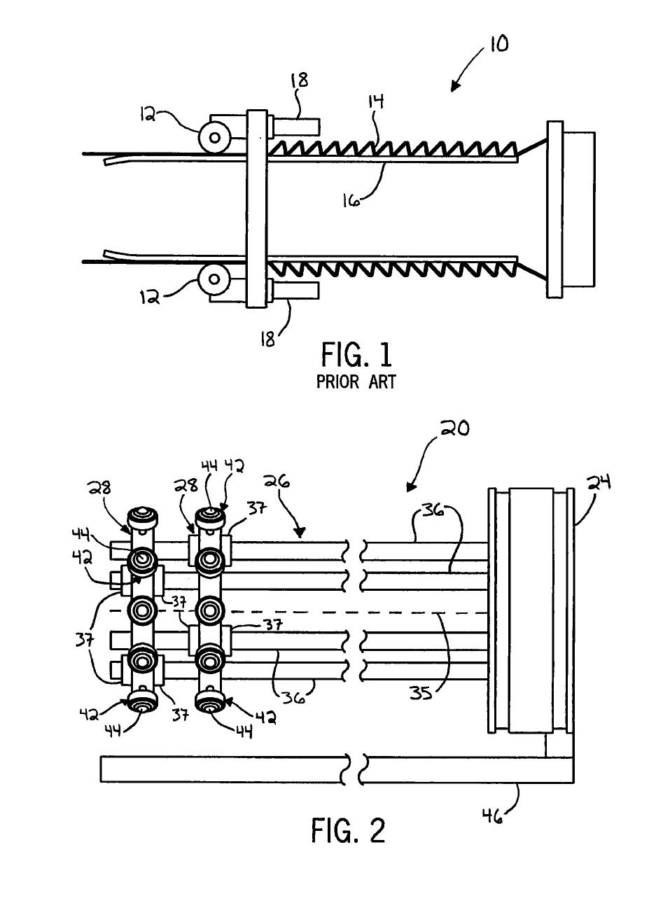

### DETAILED DESCRIPTION OF THE INVENTION

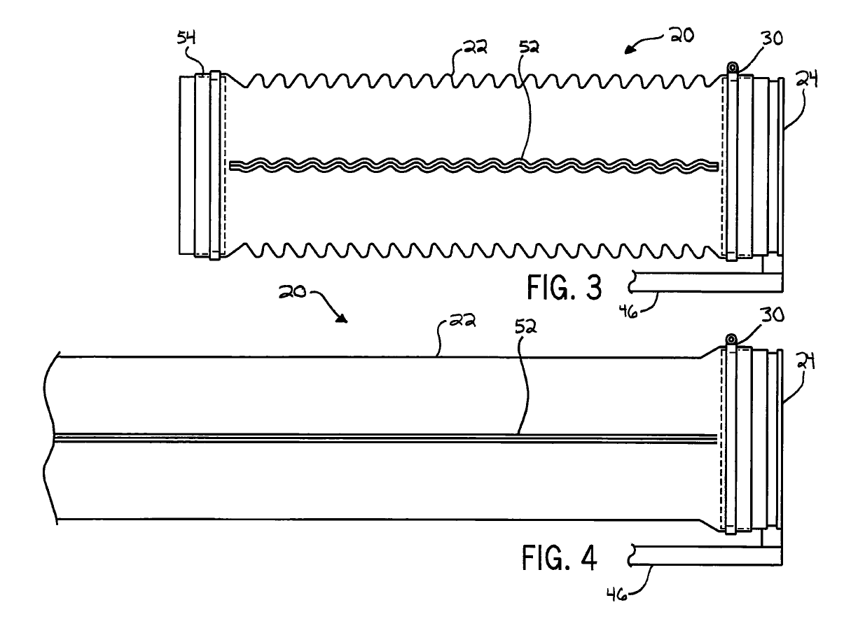

Referring now to FIGS. 2-7 and specifically to FIGS. 2 and 3, a system 20 for supporting a preconditioned air hose 22 includes a base support 24 that fixedly connects to an end of the hose 22 and a stationary bearing assembly 26 and frame assemblies 28 that engage the hose 22. The hose 22 moves between a storage position, as shown in FIG. 3, in which the hose 22 is axially compressed along the stationary bearing assembly 26, and a deployed position, as shown in FIG. 4, in which the hose 22 delivers preconditioned air from an air source (not shown) to an aircraft (not shown). In the deployed position, the hose 22 is supported by the frame assemblies 28.

Referring to FIGS. 2-5 and 8, the base support 24 is a generally circular member that fixedly connects to an end of the hose 22 by a hose clamp 30 or other similar component. The end of the base support 24 opposite the hose 22 connects to the air source or a conduit in fluid communication with the air source. Referring to FIG. 8, the base support 24 includes a plurality of support holes, two of which are indicated by reference numeral 32, to connect the stationary bearing assembly 26. The support holes 32 are advantageously spaced about the circumference of a base circle at generally equal angles from one another. For example, in the configuration shown in FIG. 8, six support holes 32 are spaced about 60 degrees from one another. The base circle has a diameter of about 8.75 inches to properly accommodate the hose 22. However, the diameter of the base circle may be varied without departing from the scope of the present invention. The base support 24 advantageously has thin walls 25 as viewed in FIG. 8. The walls 25 define a plurality of passages 34 that permit air to pass from one side of the base support 24 to the other.

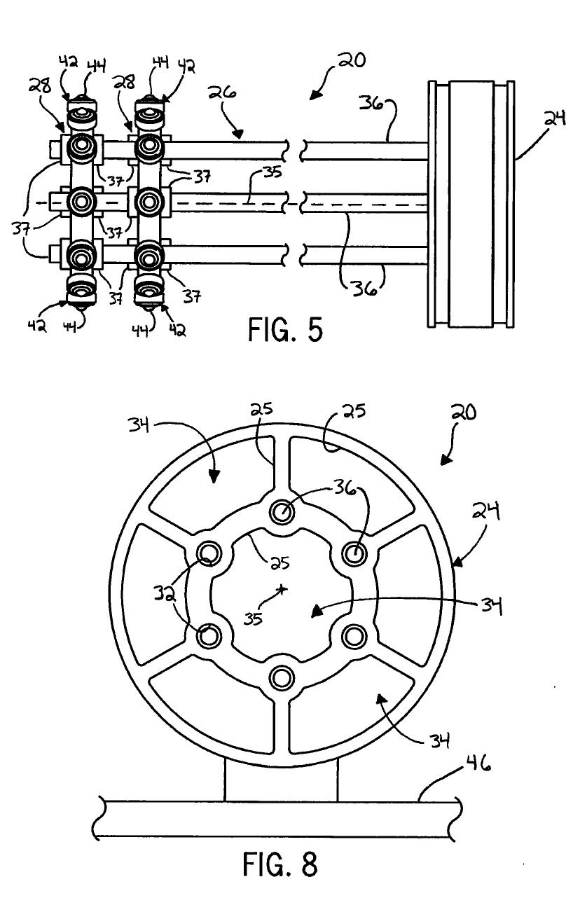

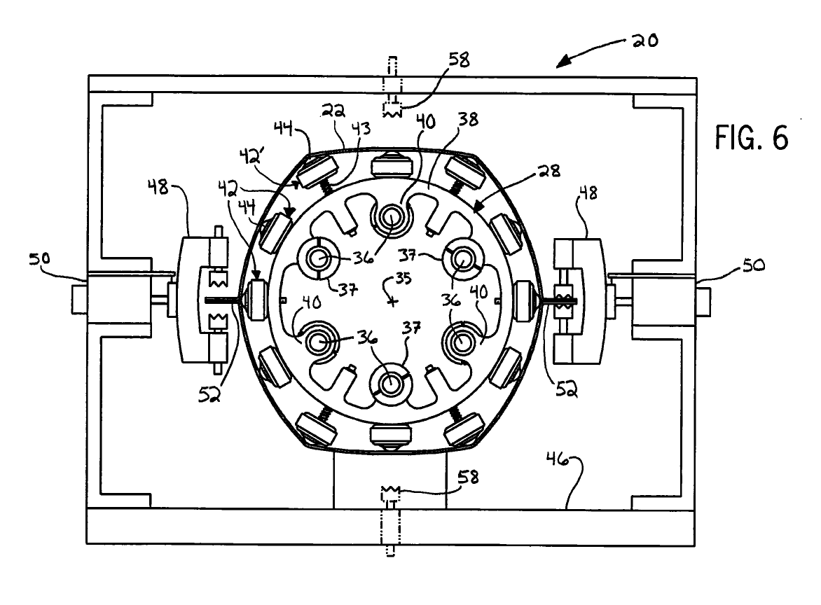

Referring to FIGS. 2 and 5, the stationary bearing assembly 26 defines a longitudinal axis 35 in the direction in which the hose 22 generally moves. The stationary bearing assembly 26 advantageously includes a plurality of longitudinal members 36 that engage the hose 22. Each longitudinal member 36 connects to the base support 24 by a single support hole 32. As such, it can be appreciated from FIGS. 6 and 8 that the longitudinal members 36 define a generally hexagonal-shaped cross-sectional area with generally equal side lengths. That is, the longitudinal members 36 are spaced about the longitudinal axis 35 at generally equal angels from one another. The longitudinal members 36 provide low resistance to airflow through the system 20 resulting in high airflow efficiency. In addition, the longitudinal members 36 are light-weight compared to similar components in prior-art designs.

Referring to FIGS. 2 and 5-7, a first of the frame assemblies 28 connects to the stationary bearing assembly 26 near an end opposite the base support 24. A second of the frame assemblies 28 connects to and is positioned along the stationary bearing assembly 26 between the first frame assembly 28 and the base support 24. The second frame assembly 28 is advantageously closer to the first frame assembly 28 than the base support 24. Referring to FIGS. 2 and 5, the first frame assembly 28 is fixed relative to the longitudinal members 36 by collars 37 connected to three of the longitudinal members 36. The second frame assembly 28 is fixed relative to the longitudinal members 36 by collars 37 connected to the other three of the longitudinal members 36.

The frame assemblies 28 are generally identical, and therefore only the first frame assembly 28 will be described in detail. Referring to FIG. 6, the first frame assembly 28 includes a generally annular-shaped member 38 having a plurality of mounting sections 40 that each engage a single longitudinal member 36. The frame assembly 28 also includes a plurality of supports, two of which are indicated by the reference numeral 42, to engage the hose 22. The supports 42 extend radially outwardly from the annular-shaped member 38. The supports 42 may be a friction reducing bearing, which should be understood as a wear material with a low coefficient of friction, a support that includes a roller element, or, as shown in the figures, a support that includes a ball element 44. The supports 42 define a cross-sectional area larger than the hexagonal area defined by the longitudinal members 36 and thereby limit the amount of friction between components of the system 20 and the hose 22. Limiting the amount of friction reduces the amount of wear experienced by the hose 22.

Referring specifically to FIG. 6, several of the supports 42′ are advantageously biased radially outwardly from the annular-shaped member 38, for example, by springs 43. Spring-biased supports 42′ advantageously compensate for variations in hose diameter due to manufacturing processes. Spring-biased supports 42′ also hold the hose 22 in a taught configuration which in turn holds the hose 22 in a proper orientation as it passes over the frame assembly 28. This aspect of the invention will be described in further detail below. The supports 42′ to the sides of the supports 42 at the 12 o'clock and 6 o'clock positions are advantageously spring-biased supports 42′ because of deflection due to the cantilevered configuration of the stationary bearing assembly 26.

Referring to FIGS. 2-4, the base support 24 connects to a frame 46 that connects to a lower surface of a jetway (not shown) or similar structure to support the system 20. The frame 46 may include joints or other components that permit the system 20 to pivot about vertical and horizontal axes relative to the lower surface of the jetway. Referring to FIG. 6, the frame 46 includes grippers 48 that move between open and closed positions to engage a portion of the hose 22. Actuators 50 move the grippers 48 generally in the direction of the longitudinal axis 35. The actuators 50 may be pneumatic actuators, hydraulic actuators, power screws, solenoid actuators, or any other type of linear actuator known in the art. Similarly, it is contemplated that the grippers 48 may take many forms.

Motion of the actuators 50 and the grippers 48 compress the hose 22 along the stationary bearing assembly 26. The grippers 48 move in a cyclic manner and engage different portions of the hose 22 in different cycles. Specifically, the grippers 48 first move to the closed position to engage the hose 22. The actuators 50 then move the grippers 48, for example, 1′ toward the base support 24. The grippers 48 then open to release the hose 22 and the actuators 50 move the grippers 48 to the original position. The cycle is then repeated. Referring to FIG. 3, the process advantageously compresses the hose 22 having a length of 70 feet along the stationary bearing assembly 26 having a length of 8 feet. The hose 22 advantageously includes seams 52 that are engaged by the grippers 48 during the retraction process. As such, the hose 22 is the hose described in U.S. patent application Ser. No. 11/700,977, the disclosure of which is hereby incorporated by reference.

The hose 22 used with the system 20 of the present invention is advantageously deployed manually by an operator. The force required to deploy the hose 22 is low due to the reduced friction provided by the frame assemblies 28. Alternatively, the hose 22 could be automatically deployed, as will be described further below. As briefly described above, the spring-biased supports 42′ hold the hose 22 in a taught configuration which in turn holds the hose 22 in a proper orientation as it passes over the frame assembly 28. Specifically, the hose 22 is held such that the seams 52 are near the grippers 48, for example, as shown in FIG. 6, at the sides of the frame assembly 28.

The hose 22 has a diameter of 14 inches, which is the same as the standard size for a coupling or tube of the preconditioned air source. However, the diameter of the hose may be varied without departing from the scope of the present invention. In addition, referring to FIG. 3, the end of the hose 22 opposite the base support 24 includes a Velcro section 54 that connects to an aircraft hatch door coupling (not shown).

The system 20 includes a switch or emergency stop (not shown) that may be pressed to stop the retraction process. This may be useful if the hose 22 becomes caught on an object or an obstruction during the retraction process. In addition, the system 20 may include a current sensor (not shown) to stop the grippers 48 and actuator 50 when the hose 22 reaches the storage position.

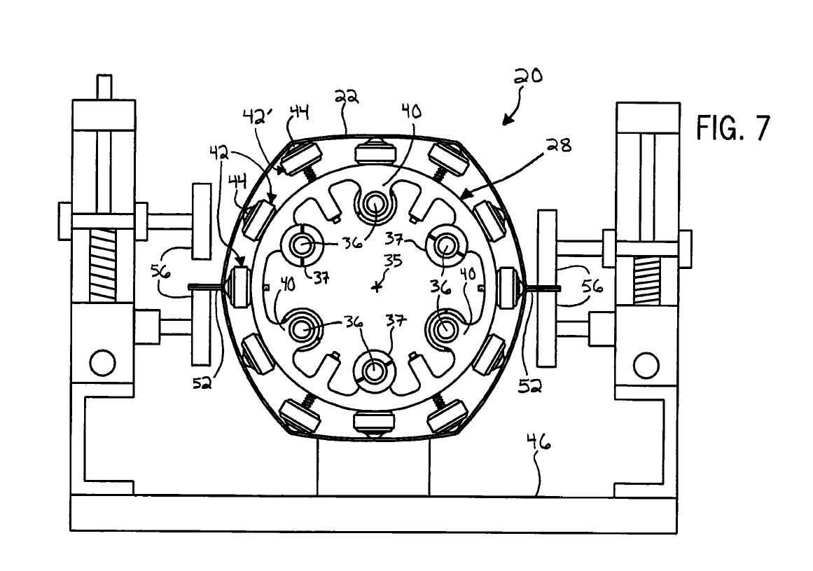

Furthermore, several design modifications are contemplated for the present invention. Referring to FIG. 7, the frame 46 may include retraction rollers 56 that engage the hose 22 instead of grippers. The retraction rollers 56 may be resilient or include serrated surfaces to ensure proper engagement with the hose 22. One of the retraction rollers 56 in each set may be a driven roller and the other may be an idler, and the retraction rollers 56 may both retract and deploy the hose 22. Alternatively, the retraction rollers 56 may be actuated to separate and disengage the hose 22 to permit manual deployment. Further still, the driven roller may include an overload clutch to limit the torque output of the retraction rollers 56.

The system 20 may be provided with only a single frame assembly 28 depending on the characteristics of the hose 22. In addition, instead of connecting to a jetway, the frame 46 may include casters (not shown) that permit the entire system 20 to be moved on the ground. Further still, sensors may be provided that monitor the position of the hose 22 during a retraction process. The sensors may be in communication with a controller that varies the displacement of the actuators 50 and the grippers 48 during the retraction process.

Further still, the frame 46 may include brakes 58 that engage the hose 22 after the retraction process. In addition, the brakes 58 may engage the hose 22 when the grippers 48 release the hose 22 during the retraction process. This may prevent the hose 22 from decompressing when released by the grippers 48. However, the hose 22 may not have a tendency to decompress depending on the specific hose used with the system 20. Referring to FIG. 6, the brakes 58 may be positioned, for example, above and below the supports 42 at the 12 o' clock and 6 o' clock positions, respectively. In addition to the design modifications described above, other modifications will be apparent to those skilled in the art.

It is also contemplated that the present invention may be provided as an unassembled kit of components for retrofitting existing systems for supporting preconditioned air hoses.

The above-described assemblies and components provide a light-weight system for moving a preconditioned air hose. The above-described system is designed to move the hose without reducing the product life of the hose and permit preconditioned air to be delivered efficiently.

The present invention has been described in terms of the various embodiments, and it should be appreciated that many equivalents, alternatives, variations, and modifications, aside from those expressly stated, are possible and within the scope of the invention. Therefore, the invention should not be limited to a particular described embodiment.

We claim:

1. A system for supporting a hose configured to deliver preconditioned air from a source to an aircraft, comprising:
a base support;
a stationary bearing assembly connected to the base support proximate a first end of the stationary bearing assembly and configured to engage the hose to support the hose; and
a frame assembly connected to the stationary bearing assembly proximate a second end of the stationary bearing assembly and having a support extending away from the frame assembly and configured to engage the hose.

2. The system of claim 1 wherein the frame assembly includes a generally annular-shaped member and a plurality of supports connected to the annular-shaped member and configured to engage an inner surface of the hose, and each of the plurality of supports extending radially outwardly from the annular-shaped member.

3. The system of claim 1 wherein the support is a friction reducing bearing.

4. The system of claim 3 wherein the support includes a ball element configured to engage the hose.

5. The system of claim 1 wherein the base support includes a plurality of passages to permit preconditioned air to pass from a first side of the base support to a second side of the base support.

6. The system of claim 1 further comprising a frame connected to the base support, and the frame being configured to connect to a jetway.

7. The system of claim 1 further comprising a second frame assembly having a generally annular-shaped member and a support configured to engage an inner surface of the hose, and the second frame assembly being connected to the stationary bearing assembly between the first frame assembly and the base support.

8. The system of claim 1 wherein the stationary bearing assembly is defined by a plurality of longitudinal members.

9. The system of claim 1 further comprising a frame connected to the base support, and the frame having grippers configured to engage a seam of the hose.

10. A system for supporting a hose configured to deliver preconditioned air from a source to an aircraft, comprising:
a base support;
a plurality of longitudinal members connected to the base support proximate a first end of the plurality of longitudinal members and configured to engage an inner surface of the hose to support the hose; and
a frame assembly connected to the plurality of longitudinal members proximate a second end of the plurality of longitudinal members and having a plurality of supports extending away from the frame assembly and configured to engage the inner surface of the hose.

11. The system of claim 10 wherein the plurality of longitudinal members defines a longitudinal axis and the plurality of longitudinal members are spaced apart from one another about the longitudinal axis at generally equal angels, and the plurality of supports are spaced apart from one another about the longitudinal axis at generally equal angles.

12. The system of claim 10 wherein the plurality of longitudinal members define a hexagonal-shaped cross-sectional area with generally equal side lengths.

13. The system of claim 12 wherein the plurality of supports define a cross-sectional area larger than the hexagonal-shaped cross-sectional area.

14. The system of claim 10 further comprising grippers configured to engage a seam of the hose and pull the hose across the plurality of supports.

15. The system of claim 14 wherein the grippers are configured to move in a cyclic manner and move a different portion of the hose into contact with the plurality of longitudinal members in different cycles.

16. A kit for retrofitting a system for supporting a hose for delivering preconditioned air to an aircraft, comprising:
a base support;
a stationary bearing assembly configured to connect to the base support and extend from the base support in a travel direction of the hose and configured to engage the hose to support the hose;
a frame assembly configured to connect to the stationary bearing assembly at a position spaced apart from the base support in the travel direction of the hose and having a support extending away from the frame assembly and configured to engage the hose.

17. The system of claim 16 wherein the frame assembly includes a generally annular-shaped member and a plurality of supports connected to the annular-shaped member and configured to engage an inner surface of the hose, and each of the plurality of supports extending radially outwardly from the annular-shaped member.

18. The system of claim 16 wherein the base support includes a plurality of passages to permit preconditioned air to pass from a first side of the base support to a second side of the base support.

19. The system of claim 16 further comprising a frame configured to connect to the base support and configured to connect to a jetway.

20. The system of claim 16 wherein the stationary bearing assembly is defined by a plurality of longitudinal members.
